(19) United States
(12) Patent Application Publication
(10) Pub. No.: US 2013/0293323 A1
(43) Pub. Date: Nov. 7, 2013

(54) ELECTROMAGNETIC WAVE TRANSMISSION SHEET

(71) Applicant: Koichiro Nakase, Tokyo (JP)

(72) Inventor: Koichiro Nakase, Tokyo (JP)

(21) Appl. No.: 13/978,129

(22) PCT Filed: Dec. 16, 2011
(86) PCT No.: PCT/JP2011/079964

§ 371 Date: Jul. 2, 2013

(30) Foreign Application Priority Data
Jan. 4, 2011 (JP) 2011-000119
Dec. 1, 2011 (JP) 2011-263752

(51) Int. Cl. H01P 3/00

(52) U.S. Cl. CPC H01P 3/00
USPC 333/236

(57) ABSTRACT

This electromagnetic wave transmission sheet is provided with: a first conductor plane; a second conductor plane arranged to be opposed the first conductor plane, and provided with a plurality of openings; a dielectric layer provided between the first conductor plane and the second conductor plane; a reflection element provided on outer edge of the dielectric layer; and a lossy material provided to cover the external side of the reflection element.

### TECHNICAL FIELD

The present invention relates to an electromagnetic wave transmission sheet to perform communication and power transmission all together

### BACKGROUND ART

As a new communication mode other than communication using fixed lines (one-dimensional communication) and three-dimensional communication using radio waves, two-dimensional communication has been proposed recent years, and some thereof are in practical use. In this two-dimensional communication, it becomes possible to inject an electromagnetic wave into a communication sheet or extract an electromagnetic wave from a communication sheet at an arbitrary place by placing a coupler, which is a dedicated electromagnetic coupling element, on the communication sheet.

Thus, as compared with the communication using fixed lines, the two-dimensional communication can realize a simple work environment with no cable. And, as compared with the communication using radio waves, since the two-dimensional communication has a property of confining electromagnetic waves inside a sheet, and thus, it brings about an advantage in that a loss due to diffusion is reduced to a greater degree, power saving can be realized.

In patent literature (PTL) 1, a technology related to a two-dimensional communication sheet is described in which a dielectric layer is interposed between a plane-shaped conductive layer and a mesh-shaped conductive layer. In this two-dimensional communication sheet, an electromagnetic wave propagating in the communication sheet leaks out from mesh openings as an evanescent wave. Through utilization of this leaked of an electromagnetic wave, either extracting an electromagnetic wave propagating in the communication sheet or injecting an electromagnetic wave into a communication sheet, is performed by using the coupler provided on the communication sheet

Moreover, this two-dimensional communication technology can be applied to not only communication but also power transmission. Specifically, by injecting high-frequency power into a communication sheet and connecting a high-frequency power supplier to a coupler, it is possible to supply electric power to an electronics device through a coupler including a rectifier.

A feature of this method is that the frequency of an electromagnetic wave for use in a communication system is not restricted. Thus, it is possible to use a plurality of frequencies in the same system. Accordingly, it becomes possible to realize communication and power transmission in the same system by separating a frequency for use in communication and a frequency for use in power transmission from each other.

### CITATION LIST

### Patent Literature

PTL 1: International Publication Number: WO2007/032339

### DISCLOSURE OF INVENTION

### Problem to be Solved by the Invention

The communication sheet described in PTL 1 is structured such that the above and below conductive layers are not connected to each other at the edge of the sheet, that is, the communication sheet is structured to be open terminated. For this reason, electromagnetic waves propagating in the sheet are reflected by the edge of the sheet. As a result, as compared with a communication sheet in which the edge of the sheet is terminated by a resistance or the like, in the communication sheet described in PTL 1, power loss is made smaller, and thus, power saving can be realized.

On the other hand, in the communication sheet described in PTL 1, there has been a problem that reflections at the edge of the sheet distort signal waveforms, and this distortion of signal waveforms makes it difficult to perform high-speed communication.

An object of the present invention is to provide a communication sheet which solves the aforementioned problem.

### Means for Solving a Problem

A electromagnetic wave transmission sheet according to an aspect of the invention includes a first conductor plane, a second conductor plane that is located opposite to the first conductor plane and that is provided with a plurality of openings, a dielectric layer that is disposed between the first conductor plane and the second conductor plane, a reflection element that is disposed in an outer edge of the dielectric layer, and a lossy material that is disposed so as to cover an outside of the reflection element.

### Effect of the Invention

The communication sheet according to an aspect of the present invention is able to realize power transmission with less power loss and high-speed communication all together.

### BRIEF DESCRIPTION OF THE DRAWINGS

FIG. 1 is a sectional view of an electromagnetic wave transmission sheet according to the first exemplary embodiment.

FIG. 2 is a top view of an electromagnetic wave transmission sheet according to the first exemplary embodiment.

FIG. 3 is plane view of an electromagnetic wave transmission sheet according to the first exemplary embodiment.

FIG. 4A is a sectional view illustrating working of an electromagnetic wave transmission sheet according to the first exemplary embodiment.

FIG. 4B is a sectional view illustrating working of an electromagnetic wave transmission sheet according to the first exemplary embodiment.

FIG. 5 is a diagram illustrating a reflection characteristic of a reflection element according to the first exemplary embodiment.

FIG. 6 is a sectional view of an electromagnetic wave transmission sheet according to the second exemplary embodiment.

FIG. 7 is a diagram showing a mushroom type EBG structure according to the second exemplary embodiment.

FIG. 8 is a sectional view of an electromagnetic wave transmission sheet according to the third exemplary embodiment.

FIG. 9 is a sectional view of an electromagnetic wave transmission sheet according to the fourth exemplary embodiment.

FIG. 10 is a top view of an electromagnetic wave transmission sheet according to the fourth exemplary embodiment.

FIG. 11 is a diagram illustrating a reflection characteristic of a short-circuited termination type one-quarter wavelength line according to the fourth exemplary embodiment.

FIG. 12 is a plane view of an electromagnetic wave transmission sheet according to the fifth exemplary embodiment.

FIG. 13 is a sectional view of an electromagnetic wave transmission sheet according to the sixth exemplary embodiment.

FIG. 14 is a plane view of an electromagnetic wave transmission sheet according to the sixth exemplary embodiment.

FIG. 15 is a plane view of an electromagnetic wave transmission sheet according to the seventh exemplary embodiment.

FIG. 16 is a plane view of an electromagnetic wave transmission sheet according to the eighth exemplary embodiment.

FIG. 17 is a top view of an electromagnetic wave transmission sheet according to the seventh exemplary embodiment.

FIG. 18 is a perspective view of a clipped portion of an electromagnetic wave transmission sheet 10 according to the seventh exemplary embodiment.

FIG. 19 is a perspective view of a clipped portion of an electromagnetic wave transmission sheet 10 according to the seventh exemplary embodiment.

FIG. 20 is a perspective view of a clipped portion of an electromagnetic wave transmission sheet 10 according to the seventh exemplary embodiment.

FIG. 21 is a perspective view of a clipped portion of an electromagnetic wave transmission sheet 10 according to the seventh exemplary embodiment.

FIG. 22 is a perspective view of a clipped portion of an electromagnetic wave transmission sheet 10 according to the seventh exemplary embodiment.

FIG. 23 is a perspective view of a clipped portion of an electromagnetic wave transmission sheet 10 according to the seventh exemplary embodiment.

FIG. 24 is a perspective view of a clipped portion of an electromagnetic wave transmission sheet 10 according to the eighth exemplary embodiment.

FIG. 25 is a perspective view of a clipped portion of an electromagnetic wave transmission sheet 10 according to the eighth exemplary embodiment.

### DESCRIPTION OF EMBODIMENTS

The preferred exemplary embodiment of the present invention will be described below by using drawings. Although the technically preferred limitations for carrying out the present invention are applied to the exemplary embodiment described below, the scope of the invention is not limited to the embodiments described below.

### First Exemplary Embodiment

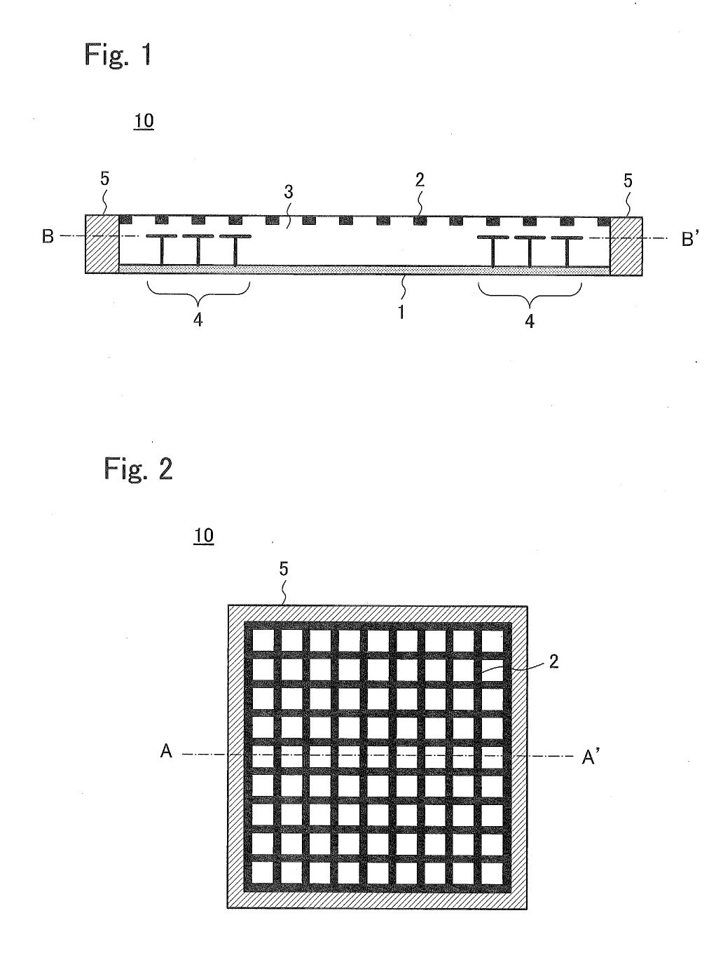

The present exemplary embodiment will be described in detail with reference to the drawings. With respect to an electromagnetic wave transmission sheet 10 according to the present exemplary embodiment, FIG. 1 is a sectional view thereof and FIG. 2 is a top view thereof. In addition, FIG. 1 is a sectional view at the position A-A′ of FIG. 2.

[Description of the Structure]

As shown in FIGS. 1 and 2, the electromagnetic wave transmission sheet 10 according to the present exemplary embodiment includes a first conductor 1, a second conductor 2, a dielectric layer 3, reflection elements 4s, and a lossy material 5.

The electromagnetic wave transmission sheet 10 according to the present exemplary embodiment has a two-layer structure in which the dielectric layer 3 of a flat plate shape is interposed between the first conductor 1 and the second conductor 2. In other words, the electromagnetic wave transmission sheet 10 is structured such that the first conductor 1, the dielectric layer 3 and the second conductor 2, which are placed so as to be opposite to one another, are laminated in an upward direction from the bottom thereof in order of this description. In addition, the quality of a material for the dielectric layer 3 of a flat plate shape is not particularly restricted, and may be, for example, hard, or soft enough to be easily bent.

The first conductor 1 is a flat-plate-shaped conductor plane having a ground electric potential. Further, FIG. 2 is a top view of the second conductor 2. As shown in FIG. 2, the second conductor 2 is a mesh-shaped conductor plane, and includes a plurality of openings in at least part of itself.

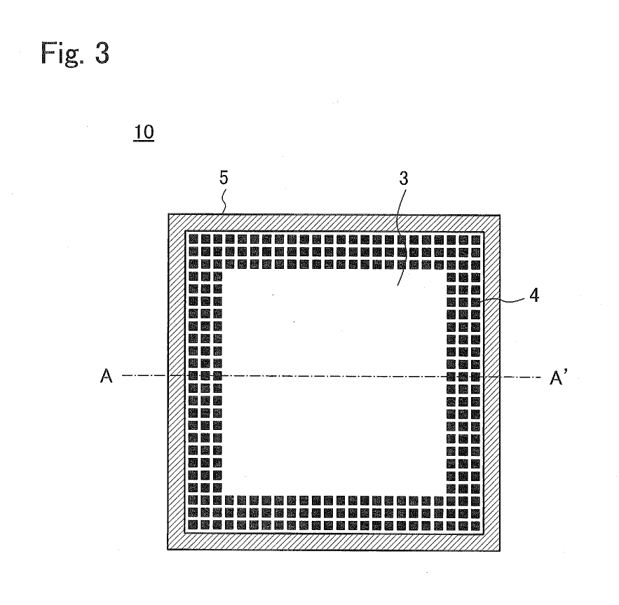

FIG. 3 is a sectional view at the position B-B′ of FIG. 1. As shown in FIG. 3, the dielectric layer 3 is provided with the reflection elements 4s in an area neighboring the edge of an outer edge thereof and existing along the entire surround of the outer edge thereof.

The reflection element 4 is only necessary to reflect an electromagnetic wave which propagates in the dielectric layer 3 and has a frequency falling within a specific frequency band (a first frequency band), and is not particularly limited. That is to say, the reflection element 4 does not reflect but pass through any electromagnetic wave whose frequency falls within any one of at least one frequency band other than the above-described specific frequency band (i.e., a second frequency band).

The lossy material 5 is disposed at the outermost side of the electromagnetic wave transmission sheet 10 along the entire surround of the outer edge so as to cover the surround of the electromagnetic wave transmission sheet 10. That is to say, the lossy material 5 is disposed at the outside of the reflection elements 4s. FIG. 1 illustrates a state where this lossy material 5 has the same thickness as that of the electromagnetic wave transmission sheet 10 which is structured such that the first conductor 1, the dielectric layer 3 and the second conductor 2 are laminated, but the thickness of the lossy material 5 is not restricted to that of the electromagnetic wave transmission sheet 10.

When an electromagnetic wave, whose frequency falls within any one of at least one band existing outside a stopband for the reflection element 4 (the second frequency band), propagates in the electromagnetic wave transmission sheet 10 and transmits through the reflection elements 4s, the lossy material 5 absorbs this electromagnetic wave and does not reflect it to inside the electromagnetic wave transmission sheet 10. In addition, the electromagnetic wave having been absorbed by the lossy material 5 is converted into heat, and this heat is diffused to outside the electromagnetic wave transmission sheet 10.

The lossy material 5 can be formed by using, for example, a conductive lossy material, a dielectric lossy material, a magnetic lossy material or the like. As specific materials for each of these kinds of lossy materials, a carbon resistance, resistance film on which metal-oxide is evaporated, or the like can be considered as the conductive lossy material, a carbon rubber, a carbon-containing foam material, or the like can be considered as the dielectric lossy material, and a ferrite sintered material, a rubber ferrite, or the like can be considered as the magnetic lossy material. Nevertheless, any material which brings about similar effects can be used without being restricted to these materials.

Here, the stopband (the first frequency band), within which frequencies of respective electromagnetic waves reflected by the reflection elements 4s fall, is designed so as to include the first frequency band for use in power transmission inside the electromagnetic wave transmission sheet 10. Meanwhile, at least one band which exists outside the stopband (the second frequency band) for the reflection element 4 is designed so as to include at least one second frequency for use in communication inside the electromagnetic wave transmission sheet 10.

[Description of the Working]

The working the present exemplary embodiment will be described.

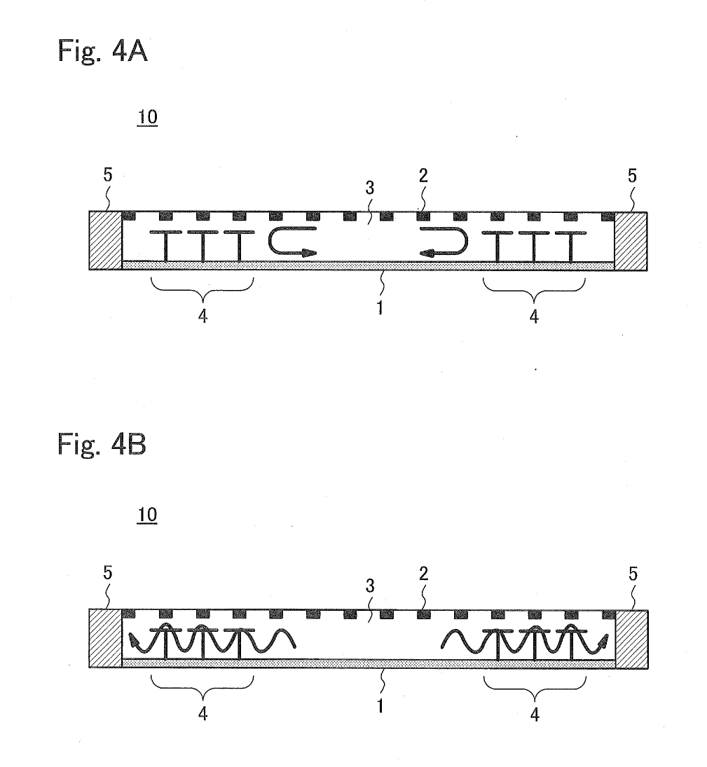

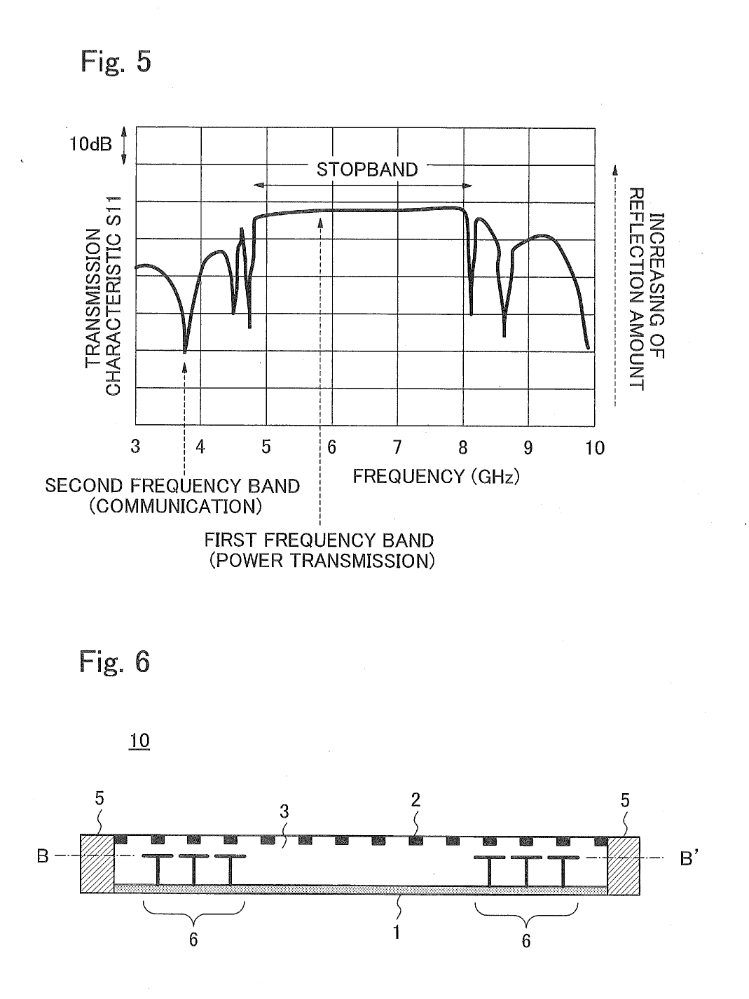

Referring to an example shown in FIG. 5 with respect to a reflection characteristic of the reflection element 4, since the first frequency band for use in power transmission inside the electromagnetic wave transmission sheet 10 is included in the stopband for the reflection element 4, an electromagnetic wave whose frequency falls within the first frequency band is reflected by the reflection element 4. That is, as shown in FIG. 4A, an electromagnetic wave for power transmission inside the electromagnetic wave transmission sheet 10 (the first frequency band) is reflected by the reflection elements 4s, which are arranged in an area neighboring the edge of the outer edge of the electromagnetic wave transmission sheet 10, and returns again to inside the electromagnetic wave transmission sheet 10.

Meanwhile, referring to the example shown in FIG. 5 with respect to a reflection characteristic of the reflection element 4, the second frequency band, which is used for communication inside the electromagnetic wave transmission sheet 10, exists outside the stopband for the reflection element 4. Thus, an electromagnetic wave whose frequency falls within the second frequency band transmits through the reflection elements 4s and reaches the lossy material 5, by which it is absorbed and converted into heat, so that it does not return to inside the sheet. That is, as shown in FIG. 4B, an electromagnetic wave for communication (the second frequency band) propagating in the electromagnetic wave transmission sheet 10 transmits through the reflection elements 4s, which are arranged in an area neighboring the edge of the outer edge of the electromagnetic wave transmission sheet 10, and reaches the lossy material 5, by which it is absorbed.

[Description of the Effects]

The effect of the present exemplary embodiment will be described.

The electromagnetic wave transmission sheet 10 according to the present exemplary embodiment is provided with the reflection elements 4s in an area neighboring the edge of the outer edge thereof and existing along the entire surround thereof. These reflection elements 4s reflect an electromagnetic wave used for power transmission, and this reflection makes leakage power less than or equal to that in the case of the open termination of the communication sheet described in PTL 1, and enables realization of power saving.

In contrast, in such a structure that the reflection elements 4s are arranged, an electromagnetic wave for use in communication is multiply reflected by the reflection elements 4s, and this multiple reflections distort a signal waveform thereof, so that this structure is deemed not to be suited for high-speed communication. For this reason, taking communication into consideration, it is desirable to, without providing the reflection elements 4s, provide an absorption edge, such as the lossy material 5, at the outside of the electromagnetic wave transmission sheet 10. That is to say, an electromagnetic wave for use in high-speed communication and an electromagnetic wave for use in power transmission need mutually different characteristics at the sheet edge portion.

Hence, the electromagnetic wave transmission sheet 10 according to the present exemplary embodiment employs a structure in which the reflection elements 4s each having a frequency dependency in its reflection characteristic are arranged. This structure reduces leakage power and thus enables realization of power saving because an electromagnetic wave for power transmission (the first frequency band) is reflected by the reflection elements 4s existing at the edge of the electromagnetic wave transmission sheet 10. Moreover, since at least one frequency band within which a frequency of a corresponding electromagnetic wave for communication falls (the second frequency band) exists outside the stopband for the reflection element 4, the electromagnetic wave for communication transmits through the reflection elements 4s and is absorbed by the lossy material 5, which is provided in an area neighboring the edge of the electromagnetic wave transmission sheet 10, so that the multiple reflections can be reduced. As a result, the electromagnetic wave transmission sheet 10 according to the present exemplary embodiment enables realization of power transmission with reduced leakage power and high-speed communication all together.

### Second Exemplary Embodiment

The second exemplary embodiment will be described by using the drawings. FIG. 6 is a sectional view of an electromagnetic wave transmission sheet 10 according to the present exemplary embodiment.

[Description of the Structure]

The different point of the present exemplary embodiment from the first exemplary embodiment is that the electromagnetic wave transmission sheet 10 includes the reflection element 4 with an electromagnetic band-gap (EBG) structure 6 as shown in FIG. 6. The structures and connection relations except for those of the EBG structure 6 according to the present exemplary embodiment are the same as those of the first exemplary embodiment.

That is to say, the electromagnetic wave transmission sheet 10 according to the present exemplary embodiment is structured such that the dielectric layer 3 of a flat plate shape is interposed by two layers of the first conductor 1 and the second conductor 2. In other words, the electromagnetic wave transmission sheet 10 is structured such that the first conductor 1, the dielectric layer 3 and the second conductor 2, which are placed so as to be opposite to one another, are laminated in an upward direction from the bottom thereof in order of this description.

The first conductor 1 is a flat-plate-shaped conductor plane having a ground electric potential. Further, FIG. 2 is a top view of the second conductor 2. As shown in FIG. 2, the second conductor 2 is a mesh-shaped conductor plane, and includes a plurality of openings in at least part of itself.

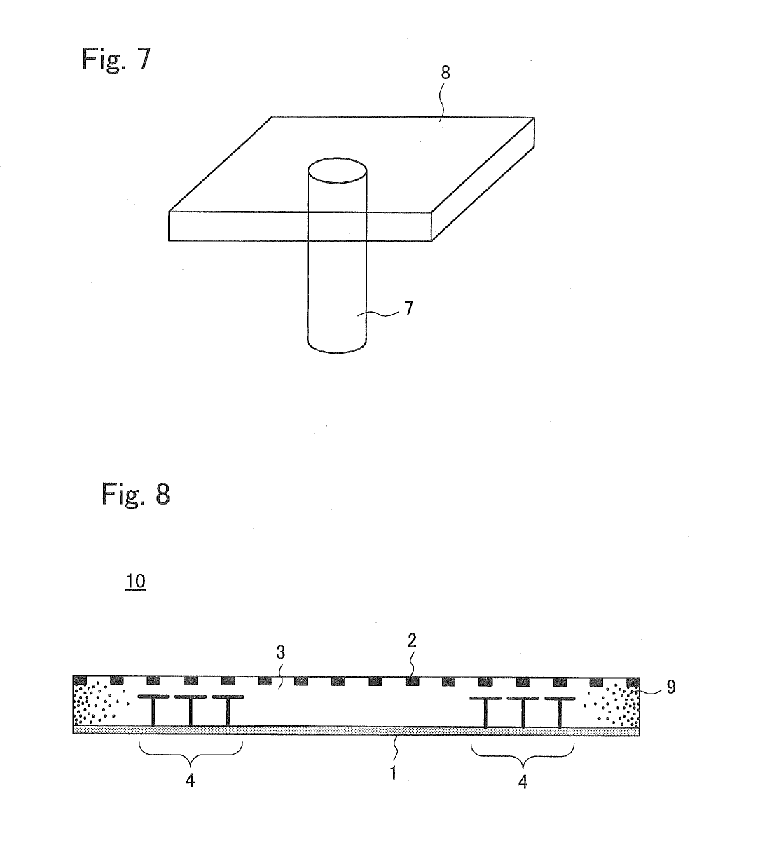

The EBG structure 6 according to the present exemplary embodiment includes a conductor via 7 and a conductor patch 8, and forms a mushroom shape shown in FIG. 7. Further, the EBG structures 6s are provided in the dielectric layer 3 which is interposed between the first conductor 1 and the second conductor 2. The EBG structures 6s are provided in an area neighboring the edge of an outer edge, and existing along the entire surround. Although, in FIG. 3, the EBG structures 6s are arranged in three rows, the number of the rows is not limited to this.

The conductor via 7 forms a cylinder shape, and electrically connects between the first conductor 1 and the conductor patch 8. The conductor patch 8, which is a flat-plate-shaped conductor forming a rectangular shape, is electrically connected to the conductor via 7, and is provided so as to be opposite to the second conductor 2. The size of the conductor patch 8 is larger than that of each of the plurality of openings included in the second conductor 2. Further, although the conductor via 7 is represented by a cylindrical shape in FIG. 7, the shape of the conductor via 7 is not limited to this shape, and may be a triangular prism or a quadratic prism provided that the shape of the conductor via 7 is a columnar one. Similarly, although the conductor patch 8 is represented by a rectangular shape in FIG. 7, the shape of the conductor patch 8 is not limited to this shape, and may be a circle, an ellipse or the like.

[Description of the Working]

The working in the present exemplary embodiment will be described.

The EBG structure 6 according to the present exemplary embodiment is an EBG of so-called mushroom type, and its unit cell is composed of the first conductor 1, the conductor via 7, the conductor patch 8, and an area being part of the second conductor 2 and opposing to the conductor patch 8.

Describing in detail, in the EBG structure 6, the second conductor 2 corresponds to an upper plane, and the first conductor 1 corresponds to a lower plane. Further, the conductor patch 8 corresponds to a head portion of a mushroom, and the conductor via 7 corresponds to an inductance portion of the mushroom. Further, this unit cell is repeatedly formed, such as alignment at intervals of a constant pitch.

In the above-described structure, an inductance component is formed by the conductor via 7, and a capacitance component is formed between the second conductor 2 and the conductor patch 8. As a result, it becomes possible to regard that the second conductor 2 and the conductor patch 8 are electrically connected (short-circuited) at a specific frequency (the first frequency band). In this case, the EBG structure 6 suppresses an electromagnetic wave whose frequency falls within the specific frequency (the first frequency band) from propagating in the electromagnetic wave transmission sheet 10, and reflects the electromagnetic wave in a direction opposite to its propagation direction. In addition, in order to allow the capacitance component to be easily formed, it is preferable that the conductor patch 8 should be located at a position opposite to the second conductor 2. For example, preferably, the location should be such that one of intersection portions of the meshes of the second conductor 2, which is a mesh-shaped conductor plane, and the central portion of the conductor patch 8 should be opposite to each other.

In the present exemplary embodiment, a specific frequency band, within which the frequency of an electromagnetic wave reflected by the EBG structure 6 falls, is used as the first frequency band for power transmission, and at least one band other than the specific frequency band is used as the at least one second frequency band for communication. In addition, it is possible to adjust the frequency location of the specific frequency band within which the frequency of an electromagnetic wave reflected by the EBG structure 6 falls by adjusting a size of the conductor patch 8, a distance and a dielectric constant between the second conductor 2 and the conductor patch 8, a diameter and a length of the conductor via 7, and the like.

[Description of the Effect]

Structured in such a manner as described above, the electromagnetic wave transmission sheet 10 according to the present exemplary embodiment allows the EBG structures 6s to reflect an electromagnetic wave for power transmission (the first frequency band), thereby enabling reduction of leakage power, thus enabling realization of power saving. Moreover, at least one frequency band within which a frequency of a corresponding electromagnetic wave for communication falls (the second frequency band) exists outside the stopband for the EBG structure 6, and thus, the electromagnetic wave for communication transmits through the EBG structures 6s. Further, the lossy material 5, which is provided in an area neighboring the edge of the electromagnetic wave transmission sheet 10, absorbs the electromagnetic wave for communication, thereby enabling reduction of multiple reflections of the electromagnetic wave for communication. As a result, the electromagnetic wave transmission sheet 10 according to the present exemplary embodiment enables realization of power transmission with reduced leakage power and high-speed communication all together.

### Third Exemplary Embodiment

The third exemplary embodiment will be described by using the drawings. FIG. 8 is a sectional view of an electromagnetic wave transmission sheet 10 according to the present exemplary embodiment.

[Description of the Structure]

As shown in FIG. 8, the electromagnetic wave transmission sheet 10 of the present exemplary embodiment is different from that of the first exemplary embodiment in that the lossy material 5 is composed of conductive particles 9 and the dielectric layer 3. The structures and connection relations except for those are the same as those of the first exemplary embodiment.

That is to say, the lossy material 5 according to the present exemplary embodiment is formed by mixing the conductive particles 9 inside the dielectric layer 3. The conductive particles 9 are provided within a constant range area along the entire surround of the outer edge of the dielectric layer 3. In addition, an inclusive ratio (a mixture proportion) of the conductive particles 9 gradually becomes larger in a direction from the central portion to the edge of the dielectric layer 3. Here, the dielectric layer 3, which composes the lossy material 5 together with the conductive particles 9, may be made of the same material as that for the continuously located dielectric layer 3 in which the reflection elements 4s or the like are provided.

In the present exemplary embodiment, similarly, the reflection elements 4s are arranged in an area neighboring the edge of the outer edge of the dielectric layer 3. In addition, in the present exemplary embodiment, the lossy material 5 and the reflection elements 4s are provided in the dielectric layer 3, and the reflection elements 4s are located at an inner side of the dielectric layer 3 than the lossy material 5 just like in the cases of the first and second exemplary embodiments.

[Description of the Working and Effect]

The working in the present exemplary embodiment will be described.

The present exemplary embodiment allows the dielectric layer 3 to internally include the lossy material 5, as the conductive particles 9, and forms the conductive particles 9 such that a mixture proportion (an inclusion ratio) of the conductive particles 9 gradually becomes larger in a direction approaching the sheet edge portion. In this way, a loss amount of each of electromagnetic waves relative to its propagation distance is given a gradient by causing the mixture proportion of the conductive particles to vary, and thereby it is possible to suppress the reflections of electromagnetic waves propagating in the electromagnetic wave transmission sheet 10 at broadband frequencies.

### Fourth Exemplary Embodiment

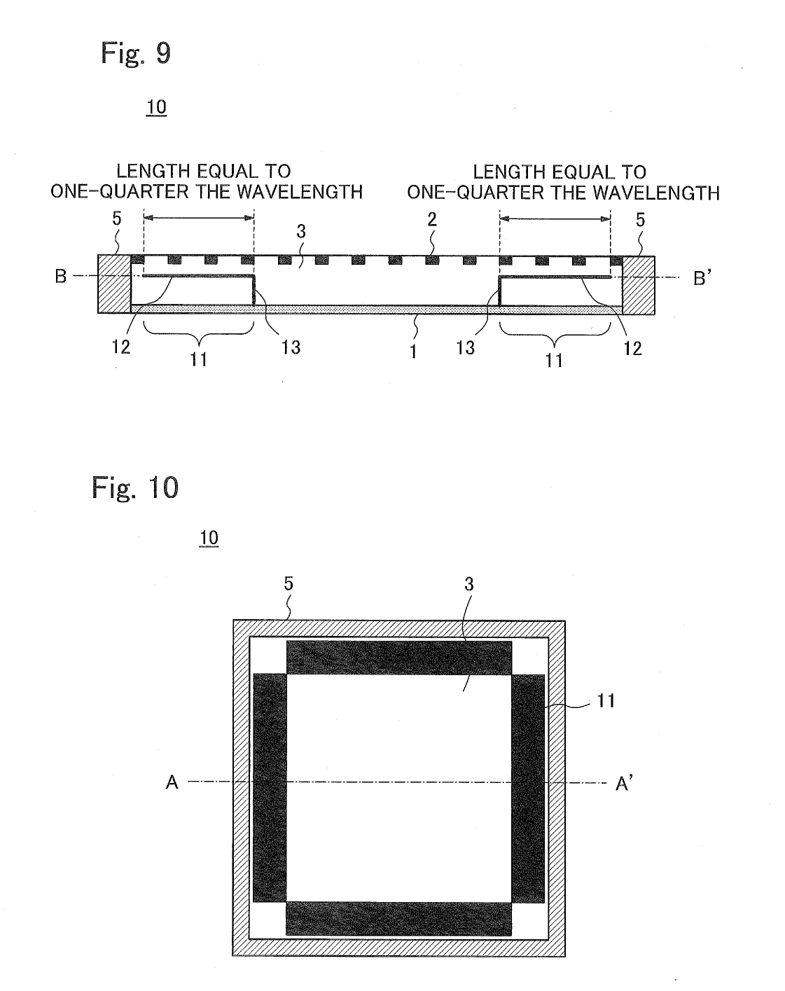

The fourth exemplary embodiment will be described by using the drawings. With respect to an electromagnetic wave transmission sheet 10 according to the present exemplary embodiment, FIG. 9 is a sectional view taken along a thickness direction thereof, and FIG. 10 is a plane view taken along a plane direction thereof. In addition, FIG. 9 is a sectional view at the position A-A′ of FIG. 10, and FIG. 10 is a sectional view at the position B-B′ of FIG. 9.

[Description of the Structure]

As shown in FIGS. 9 and 10, the electromagnetic wave transmission sheet 10 of the present exemplary embodiment is different from that of the first exemplary embodiment in that short-circuited termination type one-quarter wavelength lines 11 are used as substitute for the reflection elements 4s. The structures and connection relations except for those of the short-circuited termination type one-quarter wavelength line 11 are the same as those of the first exemplary embodiment.

That is to say, the electromagnetic wave transmission sheet 10 according to the present exemplary embodiment is structured such that the dielectric layer 3 of a flat plate shape is interposed between two layers of the first conductor 1 and the second conductor 2. In other words, the electromagnetic wave transmission sheet 10 is structured such that the first conductor 1, the dielectric layer 3 and the second conductor 2 are laminated in an upward direction from the bottom thereof in order in accordance with this description. The first conductor 1 is a ground plane, and the second conductor 2 is a mesh-shaped conductor plane (a meshed conductor). A top view of the second conductor 2 is shown in FIG. 2.

In the electromagnetic wave transmission sheet 10 according to the present exemplary embodiment, the short-circuited termination type one-quarter wavelength lines 11s are arranged as the reflection elements 4s in an area neighboring the edge of an outer edge of the dielectric layer 3. The short-circuited termination type one-quarter wavelength line 11 includes a first conductor plate 12 and a connection portion 13.

The first conductor plates 12 is a flat-plate-shaped conductor which is provided along the outer edge of the dielectric layer 3. In the case where the shape of the electromagnetic wave transmission sheet 10 is, such as rectangular as shown in FIG. 10, the first conductor plates 12s may be provided in the outer edge of the electromagnetic wave transmission sheet 10 by arranging a plurality of straight-line-shaped conductor plates in the dielectric layer 3. In addition, the shape of the first conductor plate 12 is not limited to this, and may have a curve-shaped portion in part thereof provided that the first conductor plates 12s are provided along the outer edge of the electromagnetic wave transmission sheet 10.

The first conductor plate 12 is located opposite to each of the first conductor 1 and the second conductor 2, and is provided inside the dielectric layer 3. Further, the length of the first conductor 12 in an outward direction from the inside of the electromagnetic wave transmission sheet 10 (i.e., in a direction toward the edge of the electromagnetic wave transmission sheet 10) is a first length equal to one-quarter a wavelength corresponding to a frequency which causes the largest reflection among frequencies of the first frequency band for use in power transmission, or a second length resulting from multiplying the first length by an odd number.

The first conductor plate 12 is structured such that an edge at a side near the outer edge of the electromagnetic wave transmission sheet 10 is open terminated, and an edge at a side near the inside of the electromagnetic wave transmission sheet 10 is connected to the first conductor 1, which is a ground plane, via the connection portion 13. In other words, the short-circuited termination type one-quarter wavelength line 11 is structured such that an inner-portion (central-portion) side edge of the first conductor plate 12 is connected to the connection portion 13, and an outer-portion side edge (i.e., an edge at a side near the outer edge of the electromagnetic wave transmission sheet 10) of the first conductor plate 12 is open terminated. Here, the first conductor plate 12 is structured such that a length thereof from a connection point connected to the connection portion 13 to the open terminated edge is a first length equal to one-quarter a wavelength corresponding to a frequency which causes the largest reflection among frequencies of the first frequency band for power transmission, or a second length resulting from multiplying the first length by an odd number.

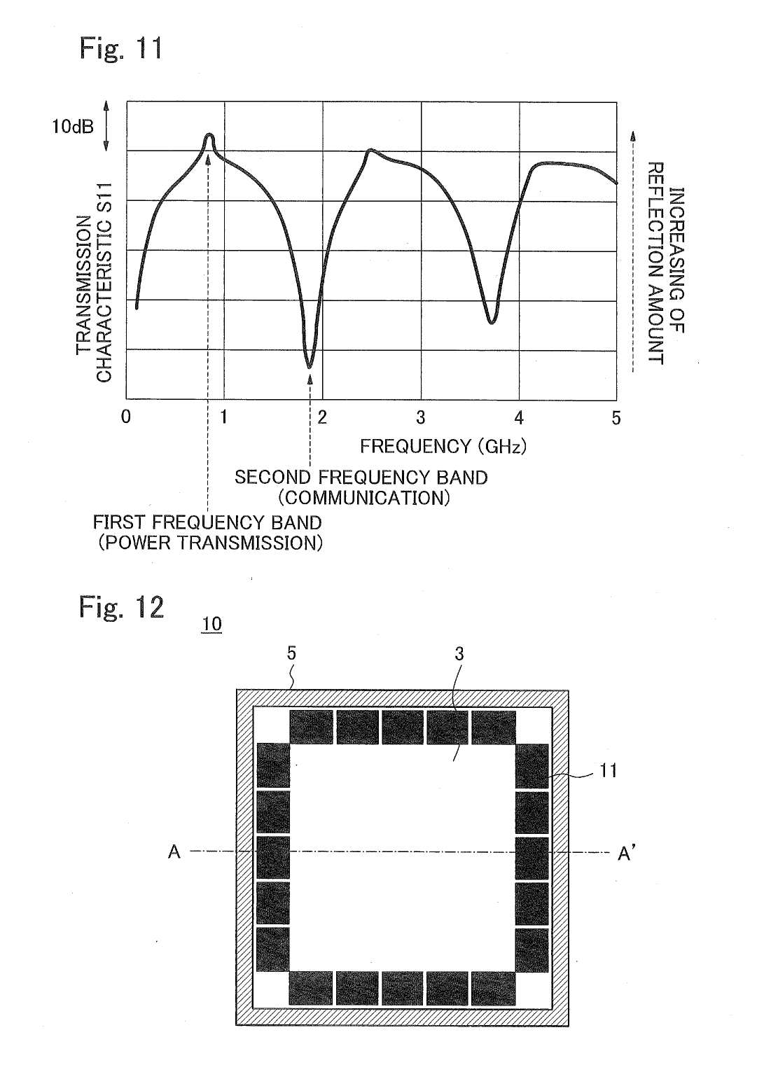

A resonance frequency of the short-circuited termination type one-quarter wavelength line 11 is designed so as to coincide with a frequency which causes the largest reflection among frequencies of the first frequency band for use in power transmission. For this reason, an electromagnetic wave whose frequencies falls within the first frequency band is reflected and returns to inside the electromagnetic wave transmission sheet 10. FIG. 11 illustrates an example of a reflection characteristic of the short-circuited termination type one-quarter wavelength line 11.

Describing in detail, when a line length of the short-circuited termination type one-quarter wavelength line 11 is a first length equal to one-quarter a wavelength corresponding to a frequency which causes the largest reflection among frequencies of the first frequency band for power transmission, or a second length resulting from multiplying the first length by an odd number, the input impedance of the short-circuited termination type one-quarter wavelength line 11 becomes infinity in theory, so that a resonance occurs.

In FIG. 11, a frequency corresponding to a first-order (a minimum-order) resonance is used for the power transmission. Alternatively, a high-order resonance can be also used for the power transmission. Further, as shown in FIG. 11, each of the at least one second frequency band for use in communication is set to, such as a frequency band in which reflections are made relatively small.

Moreover, as shown in FIG. 9, the lossy material 5 is located outside the short-circuited termination type one-quarter wavelength lines 11s. It is thought that the lossy material 5 is formed by using a conductive lossy material, a dielectric lossy material, a magnetic lossy material. In FIG. 10, the short-circuited termination type one-quarter wavelength lines 11s and the lossy material 5 are arranged so as to enclose the outer surround of the electromagnetic wave transmission sheet 10, but, in part of the outer surround, there may exist a portion in which they are not arranged.

[Description of the Working and Effect]

The working and effect of the present exemplary embodiment will be described.

As shown in FIG. 11, the first frequency band for use in power transmission is set so as to include a resonance frequency of the short-circuited termination type one-quarter wavelength line 11. As a result, an electromagnetic wave whose frequency falls within the first frequency band for use in power transmission is largely reflected at each of the short-circuited termination type one-quarter wavelength lines 11s, and thus, when an electromagnetic wave having such a frequency propagates in the electromagnetic wave transmission sheet 10, it returns to inside the electromagnetic wave transmission sheet 10.

Further, each of the at least one second frequency band for use in communication is set so as to include a frequency at which reflections are made relatively small at the short-circuited termination type one-quarter wavelength line 11. Therefore, when an electromagnetic wave having such a frequency propagates in the electromagnetic wave transmission sheet 10, it transmits through the short-circuited termination type one-quarter wavelength lines 11s which are located in an area neighboring the edge of the sheet, and reaches the lossy material 5. Further, the electromagnetic wave is converted into heat, and does not return to inside the sheet.

In the structure having been described so far with respect to the electromagnetic wave transmission sheet 10 according to the present exemplary embodiment, since an electromagnetic wave for power transmission is reflected at the edge of the electromagnetic wave transmission sheet 10, leakage power is reduced and thus power saving can be realized. Meanwhile, since an electromagnetic wave for communication is absorbed in an area neighboring the edge of the electromagnetic wave transmission sheet 10, multiple reflections can be reduced. Thus, according to the present exemplary embodiment, it is possible to realize a communication environment advantageous to perform high-speed communication.

### Fifth Exemplary Embodiment

The fifth exemplary embodiment will be described by using the drawings. FIG. 12 is sectional view of an electromagnetic wave transmission sheet 10 according to the present exemplary embodiment. FIG. 12 is a sectional view at the position B-B′ of FIG. 9 just like in FIG. 10.

[Description of the Structure]

As shown in FIG. 12, the electromagnetic wave transmission sheet 10 of the present exemplary embodiment is different from that of the fourth exemplary embodiment in that the short-circuited termination type one-quarter wavelength line 11 is divided into plural portions. The structures and connection relations except for the structure in which the short-circuited termination type one-quarter wavelength line 11 is divided into plural portions are the same as those of the first exemplary embodiment.

That is to say, as compared with the case of the fourth exemplary embodiment, the short-circuited termination type one-quarter wavelength line 11 of the electromagnetic wave transmission sheet 10 according to the present exemplary embodiment has a shape in which the first conductor plate 12 is divided into plural portions in a direction along the corresponding outer surround of the outer edge of the electromagnetic wave transmission sheet 10. In other words, the short-circuited termination type one-quarter wavelength line 11 is cut off into plural portions along an outward direction from the inside of the electromagnetic wave transmission sheet 10 (i.e., along a direction toward the edge of the electromagnetic wave transmission sheet 10), so that the width of the short-circuited termination type one-quarter wavelength line 11 is divided into small widths of the respective plural portions. In addition, according to the present exemplary embodiment, the short-circuited termination type one-quarter wavelength line 11, which is provided along each of sides of the electromagnetic wave transmission sheet 10, is divided into five portions.

[Description of the Working and Effect]

The working and effect in the present exemplary embodiment will be described.

As shown in FIG. 12, the electromagnetic wave transmission sheet 10 according to the present exemplary embodiment is structured such that each of the short-circuited termination type one-quarter wavelength lines 11s is divided into plural portions along the corresponding outer edge. Thus, the width of the short-circuited termination type one-quarter wavelength line 11 extending in an outward direction from the inside of the electromagnetic wave transmission sheet 10 becomes narrower (i.e., the length of the short-circuited termination type one-quarter wavelength line 11 in a direction along the corresponding outer periphery portion becomes shorter), so that an inter-line capacitance of a line composed of the conductor plate 12 and the first conductor 1 becomes smaller. As a result, the characteristic impedance of the short-circuited termination type one-quarter wavelength line 11 becomes larger, and the input impedance thereof can be made larger.

The input impedance of the short-circuited termination type one-quarter wavelength line 11 having been made larger makes it more difficult for an electromagnetic wave propagating in the sheet to transmit through each of the short-circuited termination type one-quarter wavelength lines 11s, as compared with the case of the fourth exemplary embodiment. Therefore, it is possible to obtain an advantage in that leakage power of an electromagnetic wave whose frequency falls within the first frequency band for power transmission can be reduced, and thus, power saving can be realized.

### Sixth Exemplary Embodiment

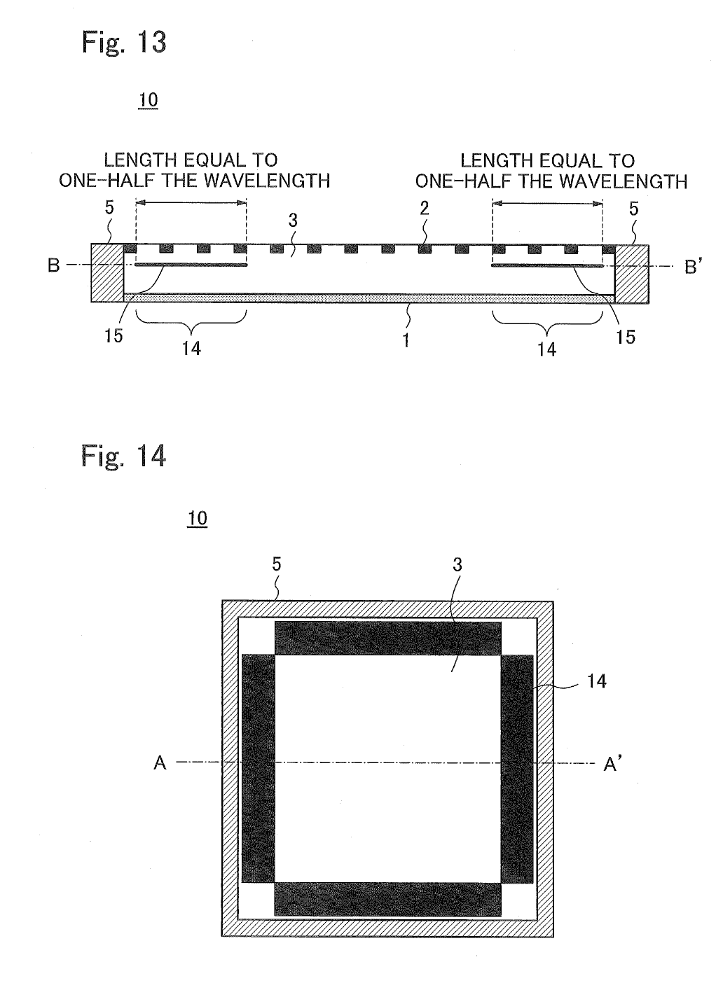

The sixth exemplary embodiment will be described by using the drawings. With respect to an electromagnetic wave transmission sheet 10 according to the present exemplary embodiment, FIG. 13 is a sectional view in its thickness direction, and FIG. 14 is a plane view in its plane direction. In addition, FIG. 13 illustrates a sectional view at the position A-A′ of FIG. 14, and FIG. 14 illustrates a sectional view at the position B-B′ of FIG. 13.

[Description of the Structure]

As shown in FIGS. 13 and 14, the electromagnetic wave transmission sheet 10 of the present exemplary embodiment is different from that of the fourth exemplary embodiment in that an open-circuited termination type one-half wavelength line 14 is used as substitute for the short-circuited termination type one-quarter wavelength line 11. The structures and connection relations except for those of the open-circuited termination type one-half wavelength line 14 are the same as those of the fourth exemplary embodiment.

That is to say, the electromagnetic wave transmission sheet 10 according to the present exemplary embodiment is characterized in that the short-circuited termination type one-quarter wavelength lines 11s are replaced by the open-circuited termination type one-half wavelength lines 14s as the reflection elements 4s which are arranged in the fourth exemplary embodiment. The open-circuited termination type one-half wavelength line 14 is composed of only a second conductor plate 15, and is not provided with the connection portion 13 which is electrically connected to the first conductor 1. That is to say, the second conductor plate 15 is not electrically connected to the first conductor 1 and the second conductor 2 (that is, it is electrically independent).

The second conductor plate 15 of the open-circuited termination type one-half wavelength line 14 is provided along the corresponding outer surround of the outer edge of the dielectric layer 3 just like the first conductor plate 12 of the fourth exemplary embodiment. For example, in the case where the shape of the electromagnetic wave transmission sheet 10 is rectangular as shown in FIG. 14, the electromagnetic wave transmission sheet 10 may be provided with second conductor plates 15s in the outer edge of the electromagnetic wave transmission sheet 10 by allowing a plurality of straight-line-shaped conductor plates to be arranged in the dielectric layer 3. In addition, the shape of the second conductor plate 15 is not limited to this, and may have a curve-shaped portion as part thereof provided that the second conductor plates 15s are provided along the outer edge of the electromagnetic wave transmission sheet 10.

The second conductor plate 15 is located opposite to each of the first conductor 1 and second conductor 2, and is provided inside the dielectric layer 3. Further, a length of the first conductor plate 12 in an outward direction from the inside of the electromagnetic wave transmission sheet 10 (i.e., in a direction toward the edge of the electromagnetic wave transmission sheet 10) is a third length equal to one-half a wavelength corresponding to a frequency which causes the largest reflection among frequencies of the first frequency band for power transmission, or a fourth length resulting from multiplying the third length by an integer.

The second conductor plate 15 is not provided with the connection portion 13, and thus, both edges thereof are open terminated. That is to say, the second conductor plate 15 is not electrically connected to the first conductor 1 and the second conductor 2.

A resonance frequency of the open-circuited termination type one-half wavelength line 14 is designed so as to coincide a frequency which causes the largest reflection among frequencies of the first frequency band for power transmission. For this reason, an electromagnetic wave whose frequency falls within the first frequency band is reflected and returns to inside the electromagnetic wave transmission sheet 10. The open-circuited termination type one-half wavelength line 14 has a reflection characteristic similar to that of the short-circuited termination type one-quarter wavelength line 11 shown in FIG. 11.

Describing in detail, when a line length of the open-circuited termination type one-half wavelength line 14 is a length resulting from multiplying a length equal to one-half a wavelength corresponding to a frequency which causes the largest reflection among frequencies of the first frequency band for power transmission by an integer, the input impedance of the open-circuited termination type one-half wavelength line 14 becomes infinity in theory, so that a resonance occurs.

In FIG. 11, a frequency corresponding to a first-order (a minimum-order) resonance is utilized for power transmission. Alternatively, a high-order resonance can be used for the power transmission. Further, as shown in FIG. 11, each of the at least one second frequency band for use in communication is set to such as a frequency at which reflections are made relatively small.

Moreover, as shown in FIG. 13, the lossy material 5 is located outside the open-circuited termination type one-half wavelength lines 14s. It is thought that the lossy material 5 is formed by using a conductive lossy material, a dielectric lossy material, a magnetic lossy material. In FIG. 14, the open-circuited termination type one-half wavelength lines 14s and the lossy material 5 are arranged so as to enclose the outer surround of the electromagnetic wave transmission sheet 10, but, in part of the outer surround, there may exist a portion in which they are not arranged.

[Description of the Working and Effect]

The working and effect in the present exemplary embodiment will be described.

As shown in FIG. 11, the first frequency band for use in power transmission is set so as to include a resonance frequency of the open-circuited termination type one-half wavelength line 14. As a result, an electromagnetic wave whose frequency falls within the first frequency band for use in power transmission is largely reflected at each of the open-circuited termination type one-half wavelength lines 14s, and thus, when an electromagnetic wave having such a frequency propagates in the electromagnetic wave transmission sheet 10, it returns to inside the electromagnetic wave transmission sheet 10.

Further, each of the at least one second frequency band for use in communication is set to a frequency band in which reflections are made relatively small by the open-circuited termination type one-half wavelength lines 14s. For this reason, when an electromagnetic wave having such a frequency propagates in the electromagnetic wave transmission sheet 10, it transmits through the open-circuited termination type one-half wavelength lines 14s located in an area neighboring the edge of the sheet, and reaches the lossy material 5. Further, the electromagnetic wave is converted into heat, and does not return to inside the sheet.

In the structure having been described so far with respect to the electromagnetic wave transmission sheet 10 according to the present exemplary embodiment, since an electromagnetic wave for power transmission is reflected at the edge of the electromagnetic wave transmission sheet 10, leakage power is reduced and thus power saving can be realized. Meanwhile, since an electromagnetic wave for communication is absorbed in an area neighboring the edge of the electromagnetic wave transmission sheet 10, multiple reflections can be reduced. Thus, according to the present exemplary embodiment, it is possible to realize a communication environment advantageous to perform high-speed communication.

As compared with the short-circuited termination type one-quarter wavelength line 11 described in the fourth exemplary embodiment, the open-circuited termination type one-half wavelength line 14 according to the present exemplary embodiment is necessary to be mounted with a larger space in a substrate surface direction, but, is unnecessary to be electrically connected to the first conductor 1 via the connection portion 13. Therefore, as compared with the short-circuited termination type one-quarter wavelength line 11, the open-circuited termination type one-half wavelength line 14 according to the present exemplary embodiment the open-circuited termination type one-half wavelength line 14 according to the present exemplary embodiment enables making the thickness of the electromagnetic wave transmission sheet 10 thinner, and thus enables making it easier to manufacture it.

### Seventh Exemplary Embodiment

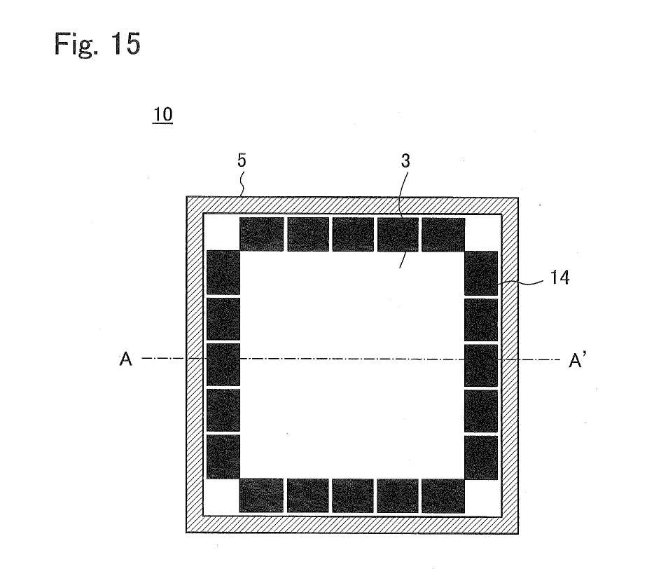

The seventh exemplary embodiment will be described by using the drawings. FIG. 15 is plane view of an electromagnetic wave transmission sheet 10 according to the present exemplary embodiment. FIG. 15 is a sectional view at the position B-B′ of FIG. 13 just like in FIG. 14.

[Description of the Structure]

As shown in FIG. 15, the electromagnetic wave transmission sheet 10 of the present exemplary embodiment is different from that of the sixth exemplary embodiment in that the open-circuited termination type one-half wavelength line 14 is divided into plural portions. The structures and connection relations except for the structure in which the open-circuited termination type one-half wavelength line 14 is divided into plural portions are the same as those of the sixth exemplary embodiment.

That is to say, as compared with the case of the sixth exemplary embodiment, the open-circuited termination type one-half wavelength line 14 of the electromagnetic wave transmission sheet 10 according to the present exemplary embodiment has a shape resulting from division into plural portions in a direction along the corresponding outer surround of the outer edge of the electromagnetic wave transmission sheet 10. In other words, the open-circuited termination type one-half wavelength line 14 is cut off into plural portions along an outward direction from the inside of the electromagnetic wave transmission sheet 10 (i.e., along a direction toward the edge of the electromagnetic wave transmission sheet 10), so that the width the open-circuited termination type one-half wavelength line 14 is divided into smaller widths of the respective plural portions. In addition, according to the present exemplary embodiment, the open-circuited termination type one-half wavelength line 14, which is provided along each of sides of the electromagnetic wave transmission sheet 10, is divided into five portions.

[Description of the Working and Effect]

The working and effect in the present exemplary embodiment will be described.

As shown in FIG. 15, the electromagnetic wave transmission sheet 10 according to the present exemplary embodiment is structured such that each of the open-circuited termination type one-half wavelength lines 14s is divided into plural portions along the corresponding outer edge. Thus, the width of the open-circuited termination type one-half wavelength line 14 extending in an outward direction from the inside of the electromagnetic wave transmission sheet 10 becomes narrower (i.e., the length of the open-circuited termination type one-half wavelength line 14 in a direction along the corresponding outer periphery portion becomes shorter), so that an inter-line capacitance of a line composed of the second conductor plate 15 and the first conductor 1 becomes smaller. As a result, the characteristic impedance of the open-circuited termination type one-half wavelength line 14 becomes larger, and the input impedance thereof can be made larger.

The input impedance of the open-circuited termination type one-half wavelength line 14 having been made larger makes it more difficult for an electromagnetic wave propagating in the sheet to transmit through the open-circuited termination type one-half wavelength lines 14s, as compared with the case of the sixth exemplary embodiment. Therefore, it is possible to obtain an advantage in that leakage power of an electromagnetic wave whose frequency falls within the first frequency band for power transmission can be reduced, and thus, power saving can be realized.

### Eighth Exemplary Embodiment

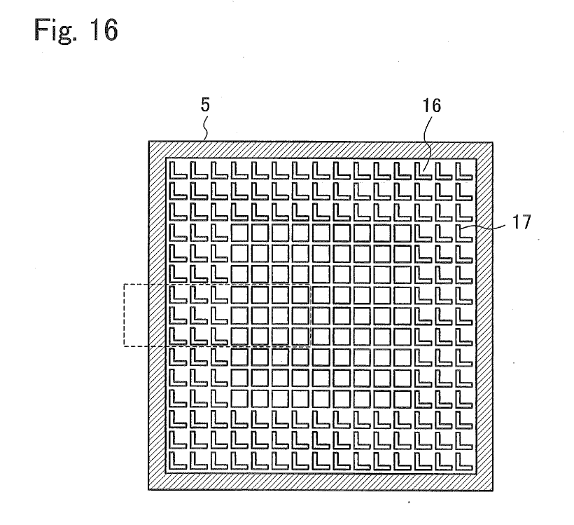

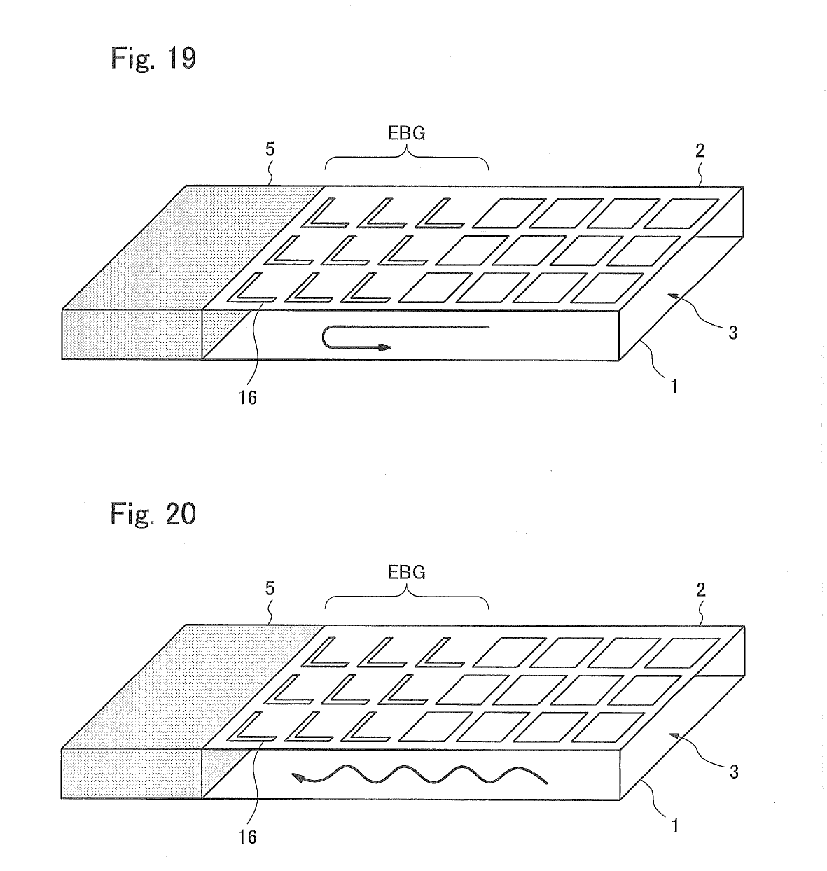

The eighth exemplary embodiment will be described by using the drawings. FIG. 16 is top view of an electromagnetic wave transmission sheet 10 according to the present exemplary embodiment. FIG. 19 is perspective view of a portion resulting from clipping part of the electromagnetic wave transmission sheet 10.

[Description of the structure]

As shown in FIG. 16, the electromagnetic wave transmission sheet 10 of the present exemplary embodiment is different from that of the second exemplary embodiment in that the second conductor 2 is provided with L-character-shaped slits 16s. The structures and connection relations except for those of the L-character-shaped slit 16 are the same as those of the second exemplary embodiment.

That is to say, the second conductor 2 according to the present exemplary embodiment is a mesh-shaped conductive plane having a plurality of openings, and includes the plurality of L-character-shaped slits 16s in an outer edge thereof. In addition, FIG. 16 illustrates, such as a state where the plurality of L-character-shaped slits 16s form three rows for each side, but the number of the rows is not limited to the present example.

The L-character-shaped slits 16s are formed on the second conductor such that they are oriented in the same direction, they are arranged at intervals of a constant pitch, and they are not contacted with one another. In addition, it is desirable that the plurality of L-character-shaped slits 16s are formed with the same pitch as that of the plurality of openings, but this condition is not necessary.

The lossy material 5 is provided at the outer periphery of the electromagnetic wave transmission sheet 10 so as to cover the first conductor 1, the second conductor 2 and the dielectric layer 3. That is to say, the lossy material 5 is provided at the outer edge of the dielectric layer 3 including the L-character-shaped slits 16s.

[Description of the Working and Effect]

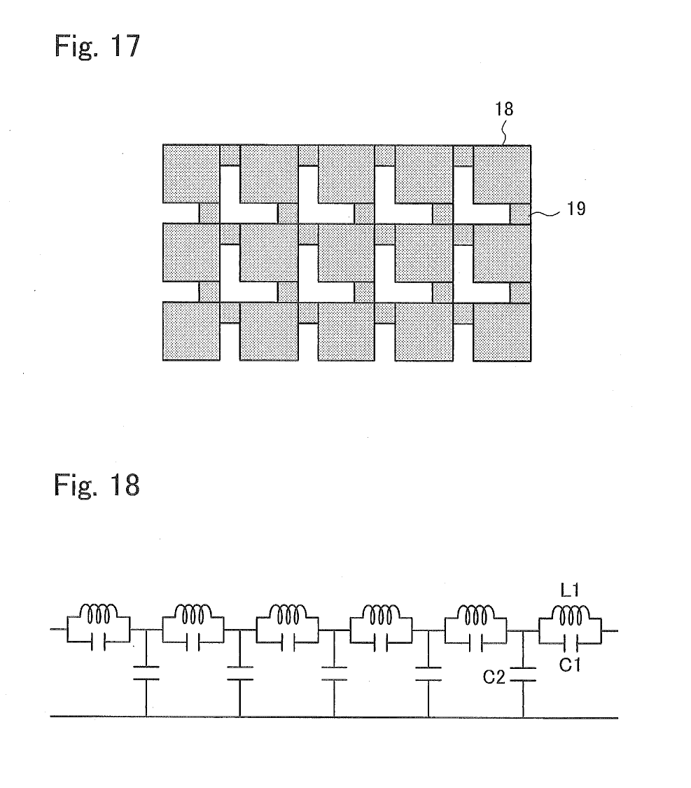

The working and effect will be described by using FIGS. 17 and 18. FIG. 17 is a diagram for describing a structure of the L-character-shaped slits 16s shown in FIG. 16. FIG. 18 is a diagram illustrating an equivalent circuit of the L-character-shaped slits 16s.

As shown in FIG. 17, each of the L-character-shaped slits 16s formed in the second conductor 2 is composed of a conductor plate 17 and a conductor plate connection portion 18. A plurality of the conductor plates 17s, which is provided so as to be opposite to the first conductor 1, is arranged at intervals of a predetermined space. Further, any adjacent ones of the conductor plates 17s are electrically connected to each other via the conductor plate connection portion 18. Here, let us consider the equivalent circuit of the L-character-shaped slits 16s.

It is assumed that, with respect to the L-character-shaped slits 16s, a first capacitance C1 is formed between any adjacent ones of the conductor plates 17s, an inductance L1 is formed at each of the conductor plate connection portions 18s, which connects corresponding adjacent ones of the conductor plates 17 to each other, and a second capacitance C2 is formed between each of the conductor plates 17s and the second conductor 2.

A resonance frequency of the equivalent circuit of the L-character-shaped slits 16s is determined by the values of the respective C1, C2 and L1. Further, the resonance frequency of this equivalent circuit corresponds to a stopband frequency for EBG structures composed by the L character-shaped slit 16. That is, the L-character-shaped slit 16 indicates a characteristic as a meta-material.

In the present exemplary embodiment, the first frequency band for use in power transmission is set so as to correspond to a resonance frequency of the L-character-shaped slits 16s, that is to say, a stopband for the EBG structures, and each of the at least one second frequency band for use in communication is set so as to correspond to one of at least one band outside the stopband for the EBG structures. That is to say, the size and the arrangement space with respect to the conductor plate 17 and the conductor plate connection portion 18 composing the L-character-shaped slits 16s are designed so as to satisfy the values of the respective C1, C2 and L1, which are suitable for a desired stopband frequency.

An electromagnetic wave for power transmission (the first frequency band) propagating in the electromagnetic wave transmission sheet 10 is reflected at the L-character-shaped slits 16s arranged in an area neighboring the outer edge of the electromagnetic wave transmission sheet 10 as shown in FIG. 19, and returns again to inside the electromagnetic wave transmission sheet 10.

Meanwhile, since each of the at least one second frequency band for use in communication exists outside the stopband for the EBG structures, as shown in FIG. 20, when an electromagnetic wave whose frequency falls within any one of the at least one second frequency band propagates in the electromagnetic wave transmission sheet 10, it transmits through the EBG structures and reaches the lossy material 5. Further, the electromagnetic wave is absorbed and converted into heat by the lossy material 5, and does not return to inside the sheet.

In other words, since an electromagnetic wave for power transmission (the first frequency band) is reflected by the EBG structures, leakage power is reduced, and thus, power saving can be realized. Moreover, since the at least one second frequency exists outside the stopband for the EBG structures, an electromagnetic wave for communication (the second frequency band) transmits through the EBG structures. Further, the lossy material 5, which is provided in an area neighboring the electromagnetic wave transmission sheet 10, absorbs the electromagnetic wave for communication, thereby enabling reduction of the multiple reflections of the electromagnetic wave.

As described above, the electromagnetic wave transmission sheet 10 according to the present exemplary embodiment enables realization of the above-described power transmission with reduced leakage power and high-speed communication all together, merely by implementing a structure which allows the L-character-shaped slits 16s to be provided on the second conductor 2, that is to say, merely by implementing a two-layer structure which allows the dielectric layer 3 to be provided between the first conductor 1 and the second conductor 2. Therefore, according to the present exemplary embodiment, it is possible to make the thickness of the electromagnetic wave transmission sheet 10 further thinner.

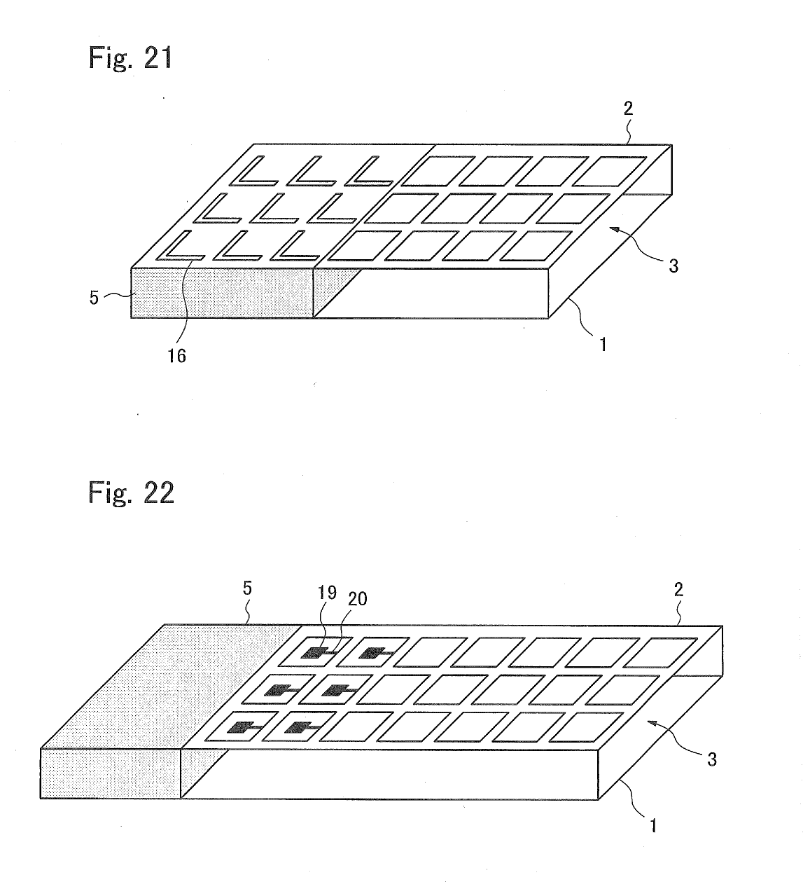

In addition, a structure, in which, as shown in FIG. 21, the lossy material 5 is inserted between the first conductor 1 and the second conductor 2 which are included in the outer edge of the electromagnetic wave transmission sheet, also brings about the same advantageous effects.

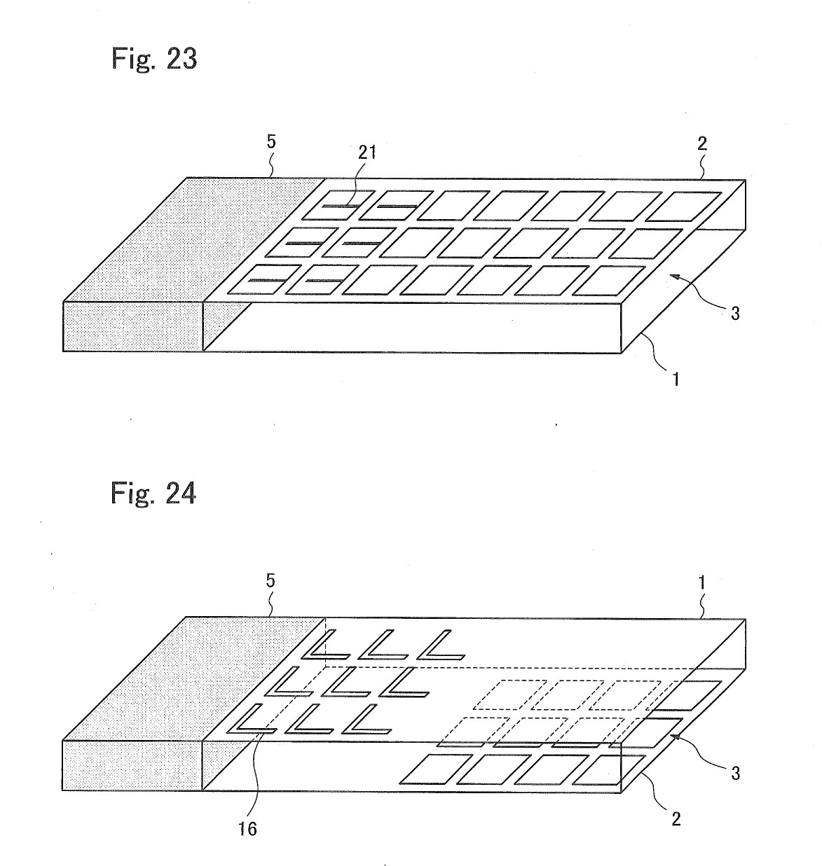

In addition, the shape of the conductor composing the EBG structure according to the present exemplary embodiment is not limited to the L-character shape provided that the EBG structure has a two-layer structure in which the dielectric layer 3 is provided between the first conductor 1 and the second conductor 2. For example, as shown in FIG. 22, an EBG structure composed of an island-shaped conductor 19 and an island-shaped conductor connection portion 20 may be applied to each of the plurality of openings of the second conductor 2. Further, as shown in FIG. 23, an open-stub type EBG structure composed of a conductor line 21 may be applied to the inside of each of the plurality of openings of the second conductor 2.

Further, in the EBG structure shown in FIG. 22, a third capacitance C3 is formed between the island-shaped conductor 19 and the first conductor 1, and an inductance L3 is formed at the island-shaped conductor connection portion 20 which electrically connects the island-shaped conductor 19 and the second conductor 2.

Further, a resonance frequency of an equivalent circuit for the EBG structures shown in FIG. 22 is determined by the values of the respective C3 and L3. This resonance frequency of the equivalent circuit corresponds to a frequency included in a stopband for the EBG structures. As described above, the island-shaped conductors 19s are formed on the same layer as the second conductor 2, and thus, power transmission with reduced leakage power and high-speed communication can be realized all together merely by implementing the two-layer structure. Therefore, according to the present exemplary embodiment, it is possible to make the thickness of the electromagnetic wave transmission sheet 10 further thinner.

Next, in the open-stub type EBG structure shown in FIG. 23, the conductor line 21 provided in each of the plurality of openings of the second conductor 2 forms a microstrip line between the first conductor 1 and itself. Therefore, a resonance frequency of an equivalent circuit of the EBG structures shown in FIG. 23 is determined by the length of the conductor line 21, and further, this resonance frequency of the equivalent circuit corresponds to a frequency of the stopband for the EBG structures.

As described above, the conductor lines 21s are formed on the same layer as the second conductor 2, and thus, power transmission with reduced power leakage and high-speed communication can be realized all together merely by implementing the two-layer structure. Therefore, according to the present exemplary embodiment, it is possible to make the thickness of the electromagnetic wave transmission sheet 10 further thinner. In addition, the EBG structures shown in each of FIGS. 22 and 23 are formed in accordance with the plurality of openings of the second conductor 2, but the pitch and the size of each of the openings are not limited to this example.

It is possible to adjust the resonance frequencies of the EBG structures shown in FIGS. 22 and 23 by changing the lengths of the island-shaped conductor connection portion 20 and the conductive line 21, respectively. Therefore, a meander shape or a spiral shape may be employed as each of the shapes of the island-shaped conductor connection portion 20 and the conductive line 21.

### Ninth Exemplary Embodiment

The ninth exemplary embodiment will be described by using the drawings. FIG. 24 is perspective view of a portion resulting from clipping part of the electromagnetic wave transmission sheet 10 according to the present exemplary embodiment.

[Description of the Structure]

As shown in FIG. 24, the electromagnetic wave transmission sheet 10 of the present exemplary embodiment is different from that of the eighth exemplary embodiment in the regard that the first conductor 1 is provided with the L character-shaped slits 16s. The structures and connection relations except for those of the L-character-shaped slit 16 are the same as those of the second exemplary embodiment.

As shown in FIG. 24, the electromagnetic wave transmission sheet 10 according to the present exemplary embodiment is structured such that the L character-shaped slits 16s are formed on the first conductor 1. That is to say, the L-character-shaped slits 16s are formed inside the first conductor 1. Further, the second conductor 2 is a mesh-shaped conductive plane having a plurality of openings.

[Description of the Working and Effect]

Since the electromagnetic wave transmission sheet 10 according to the present exemplary embodiment is structured such that the first conductor includes the L-character-shaped slits 16s formed thereon, and the second conductor opposing the first conductor is provided with a plurality of openings, and a seamless pattern on its portion opposing the L-character-shaped slits 16s of the first conductor, the electromagnetic wave transmission sheet 10 according to the present exemplary embodiment brings about the same advantageous effects as those of the eighth exemplary embodiment.

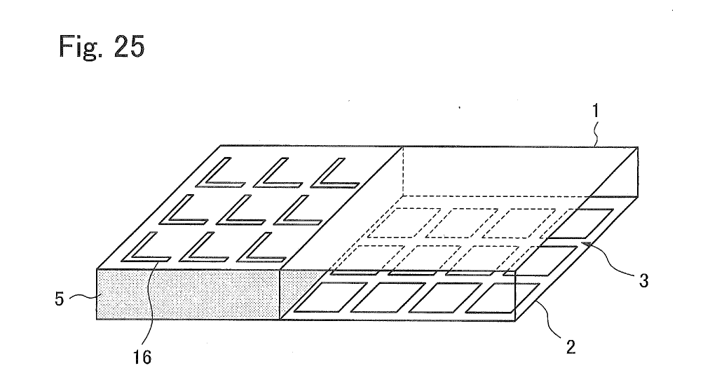

Moreover, a structure, in which, as shown in FIG. 25, the lossy material 5 is inserted between the first conductor 1 and the second conductor 2 of the outer edge of the electromagnetic wave transmission sheet, also brings about the same advantageous effects.

In addition, in the EBG structure according to the present exemplary embodiment, the shape of the conductor is not limited to the L-character shape. For example, the EBG structure composed of the island-shaped conductor 19 and the island-shaped conductor connection portion 20, which are provided in each of the plurality of openings of the second conductor 2, as shown in FIG. 22, may be applied. Further, the open-stub type EBG structure composed of the conductive line 21, which is provided in each of the plurality of openings of the second conductor 2 as shown in FIG. 23, may be applied.

The present invention has been explained in line with the exemplary embodiment and the example mentioned above. However, the present invention is not limited to the structures of the exemplary embodiment and the example mentioned above. It goes without saying that various changes or modifications within the scope of the present invention that will be performed by those skilled in the art are also included in the scope of the invention.

Further, this application is based upon and claims the benefit of priority from Japanese Patent Application No. 2011-000119, filed on Jan. 4, 2011 and Japanese Patent Application No. 2011-263752, filed on Dec. 1, 2011, the disclosure of which is incorporated herein in its entirety by reference.

### [Supplementary Note 1]

An electromagnetic wave transmission sheet comprising: a first conductor plane; a second conductor plane located opposite to the first conductor plane and comprising a plurality of openings; a dielectric layer disposed between the first conductor plane and the second conductor plane; a reflection element disposed on an outer edge of the dielectric layer; and a lossy material disposed so as to cover an outside of the reflection element.

### [Supplementary Note 2]

The electromagnetic wave transmission sheet according to supplementary note 1, wherein the reflection element reflects an electromagnetic wave in a specific frequency band, and the lossy material absorbs an electromagnetic wave outside the specific frequency band, through which electromagnetic waves propagate in the dielectric layer.

### [Supplementary Note 3]

The electromagnetic wave transmission sheet according to supplementary note 2, wherein the electromagnetic wave in a specific frequency band is an electromagnetic wave for power transmission and the electromagnetic wave outside the specific frequency band comprises an electromagnetic wave for communication.

### [Supplementary Note 4]

The electromagnetic wave transmission sheet according to any one of supplementary notes 1, 2, and 3, wherein the lossy material is one of a conductive lossy material, a dielectric lossy material, and a magnetic lossy material.

[Supplementary note 5]

The electromagnetic wave transmission sheet according to any one of supplementary notes 1, 2, 3, and 4, wherein the reflection element is composed of an electromagnetic band-gap (EBG) structure.

### [Supplementary Note 6]

The electromagnetic wave transmission sheet according to supplementary note 5, wherein the EBG structure is composed of a conductor patche that faces the second conductor plane and is larger than each of the openings in size, and a conductor via that electrically connects the conductor patche to the first conductor plane.

### [Supplementary Note 7]

The electromagnetic wave transmission sheet according to any one of supplementary notes 1, 2, 3, and 4, wherein the lossy material is composed of a dielectric material comprising conductive particles, and an inclusion ratio of the conductive particles in the dielectric layer gradually increases toward an outward direction.

### [Supplementary Note 8]

The electromagnetic wave transmission sheet according to any one of supplementary notes 1, 2, 3, and 4, wherein the reflection element comprises a first conductor plate that faces the second conductor plane, and a connection portion that electrically connects the first conductor plate to the first conductor plane; wherein the first conductor plate is in length equal to one-quarter a wavelength of electromagnetic wave with predetermined frequency or in length equal to an odd multiple of the one-quarter a wavelength, extending toward an outward direction from a point connected to the connection portion.

### [Supplementary Note 9]

The electromagnetic wave transmission sheet according to any one of supplementary notes 1, 2, 3, and 4, wherein the reflection element comprises a second conductor plate that faces the second conductor plane, wherein the second conductor plate is in length equal to one-half a wavelength of electromagnetic wave with predetermined frequency or in length equal to the integral multiple of the one-half a wavelength, and the first conductor plane and the second conductor plane are not electrically connected to each other.

### [Supplementary Note 10]

The electromagnetic wave transmission sheet according to supplementary note 8 or supplementary note 9, wherein one of the first conductor plate and the second conductor plate is divided into plural portions in a direction along an outer edge of the dielectric layer.

### [Supplementary Note 11]

The electromagnetic wave transmission sheet according to any one of supplementary notes 1, 2, 3, and 4, wherein each of the at least one reflection element is an L-character-shaped slit which is formed on the second conductor plane.

### [Supplementary Note 12]

The electromagnetic wave transmission sheet according to any one of supplementary notes 1, 2, 3, and 4, wherein each of the at least one reflection element is an L-character-shaped slit which is formed on the first conductor plane.

### DESCRIPTION OF THE CODES

1 First conductor
2 Second conductor
3 Dielectric layer
4 Reflection element
5 Lossy material
6 EBG structure
7 Conductor via
8 Conductor patch
9 Conductive particles
10 Electromagnetic propagation sheet
11 Short-circuited termination type one-quarter wavelength line
12 First conductor plate
13 Connection portion
14 Open-circuited termination type one-half wavelength line
15 Second conductor plate
16 L-character-shaped slit
17 Conductor patch
18 Conductor patch connection portion
19 Island-shaped conductor
20 Island-shaped conductor connection
21 Conductor line

1. An electromagnetic wave transmission sheet comprising:
a first conductor plane;
a second conductor plane located opposite to the first conductor plane and comprising a plurality of openings;
a dielectric layer disposed between the first conductor plane and the second conductor plane;
a reflection element disposed on an outer edge of the dielectric layer; and
a lossy material disposed so as to cover an outside of the reflection element.

2. The electromagnetic wave transmission sheet according to claim 1, wherein
the reflection element reflects an electromagnetic wave in a specific frequency band, and
the lossy material absorbs an electromagnetic wave outside the specific frequency band, through which electromagnetic waves propagate in the dielectric layer.

3. The electromagnetic wave transmission sheet according to claim 2, wherein
the electromagnetic wave in a specific frequency band comprises an electromagnetic wave for power transmission, and
the electromagnetic wave outside the specific frequency band comprises an electromagnetic wave for communication.

4. The electromagnetic wave transmission sheet according to claim 1, wherein the lossy material comprises one of a conductive lossy material, a dielectric lossy material, and a magnetic lossy material.

5. The electromagnetic wave transmission sheet according to claim 1, wherein the reflection element is comprises an electromagnetic band-gap (EBG) structure.

6. The electromagnetic wave transmission sheet according to claim 5, wherein
the EBG structure comprises a conductor patche that faces the second conductor plane and is larger than each of the openings in size, and a conductor via that electrically connects the conductor patche to the first conductor plane.

7. The electromagnetic wave transmission sheet according to claim 1, wherein
the lossy material comprises a dielectric material comprising conductive particles, and an inclusion ratio of the conductive particles in the dielectric layer gradually increases toward an outward direction.

8. The electromagnetic wave transmission sheet according to claim 1, wherein
the reflection element comprises
a first conductor plate that faces the second conductor plane, and
a connection portion that electrically connects the first conductor plate to the first conductor plane;
wherein the first conductor plate is in length equal to one-quarter a wavelength of electromagnetic wave with predetermined frequency or in length equal to an odd multiple of the one-quarter a wavelength,
extending toward an outward direction from a point connected to the connection portion.

9. The electromagnetic wave transmission sheet according to claim 1, wherein
the reflection element comprises
a second conductor plate that faces the second conductor plane, wherein
the second conductor plate is in length equal to one-half a wavelength of electromagnetic wave with predetermined frequency or in length equal to the integral multiple of the one-half a wavelength, and
the first conductor plane and the second conductor plane are not electrically connected to each other.

10. The electromagnetic wave transmission sheet according to claim 8, wherein one of the first conductor plate and the second conductor plate is divided into plural portions in a direction along an outer edge of the dielectric layer.
